(19) United States
(12) Patent Application Publication
(10) Pub. No.: US 2013/0104623 A1
(43) Pub. Date: May 2, 2013

(54) SYSTEM AND METHOD FOR TESTING SHOCK-RESISTANCE OF AN OBJECT

(71) Applicant: Feng-Chi YANG, Tu-Cheng (TW)

(72) Inventor: Feng-Chi YANG, Tu-Cheng (TW)

(73) Assignee: HON HAI PRECISION INDUSTRY CO., LTD., Tu-Cheng (TW)

(21) Appl. No.: 13/600,237

(22) Filed: Aug. 31, 2012

(30) Foreign Application Priority Data
Oct. 31, 2011 (CN) 201110337313.2

(51) Int. Cl. G01N 3/30; G01N 3/34

(52) U.S. Cl. 73/12.12; 73/12.09

(57) ABSTRACT

An impact test system includes an impact body, a rotating device and a stationary device. The rotating device is configured to rotate around a central axis holding a test object. The stationary device supports an impact body and can move the impact body into the circular path of the test object. Each of the test object and the impact body can be held by the rotating device, and each of the test object and the impact body is capable of being fixed on the stationary device.

### BACKGROUND

1. Technical Field

The present disclosure generally relates to a test system and method, especially to a system and method for testing the shock-resistance of an object, such as a display panel.

2. Description of Related Art

A display device needs to pass a plurality of tests before it is put on the market. An impact test is used to test the impact performance or the shock-resistance of the display device. In testing, a tester positions of a display device on a test desk, and then uses an impact ball to impact the display device. However, in real-life use of the display device, the display device is not always static when the display device impacts with other bodies, thus the factory test result may deviate from the real shock-resistant ability of the display device.

What is needed, therefore, is a means which can overcome the described limitations.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is an isometric view of an impact test system according to an exemplary embodiment of the present disclosure, the impact test system in a first test state and including a rotating device and a fixing device.

FIG. 2 is an isometric view of the rotating device of the impact test system in FIG. 1.

FIG. 3 is a block diagram of a driving system of the impact test system in FIG. 1.

FIG. 4 is an isometric view of the impact test system in a second test state.

FIG. 5 is a flowchart of steps S10-S13 of an impact test method utilizing the impact test system in FIG. 1.

FIG. 6 is a flowchart of steps S14-S16 of an impact test method utilizing the impact test system in FIG. 1.

### DETAILED DESCRIPTION

Reference will be made to the drawings to describe the embodiments.

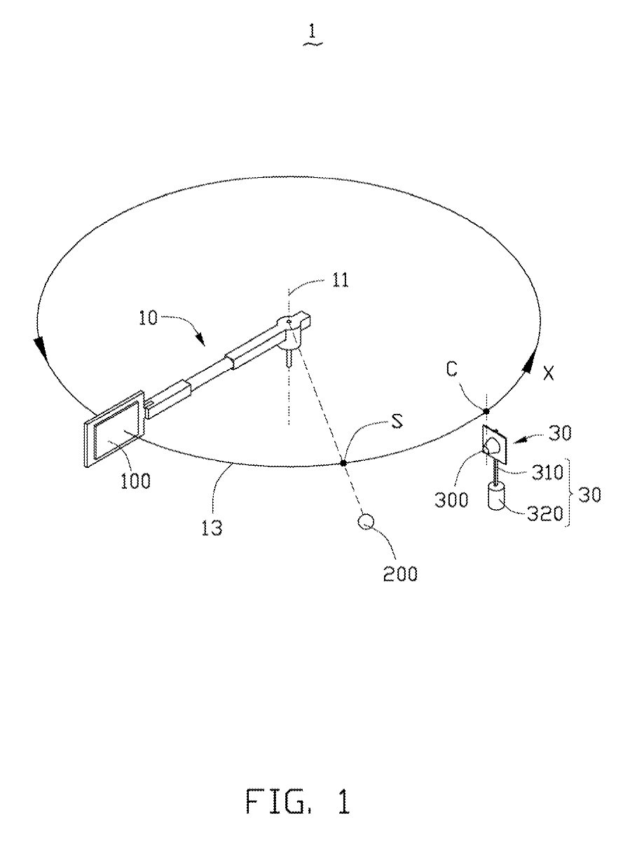

FIG. 1, illustrates a test system 1 in accordance with an exemplary embodiment. The test system 1 is configured to simulate an impact between a first body 100 and a second body 300, and obtain a result quantifying the shock-resistance of the first body 100 or the second body 300. In the embodiment, the first body 100 serves as a body under test, and the second body 300 serves as an impact component.

The test system 1 includes a rotating device 10 and a stationary device 30. The rotating device 10 is rotatable around a center axis 11. One of the first and second bodies 100, 300, such as the first body 100, is mounted on the rotating device 10, and moves together with the rotating device 10. The stationary device 30 is configured to support the non-moving body, such as the second body 300, and can locate the second body 300 in the path of the moving first body 100.

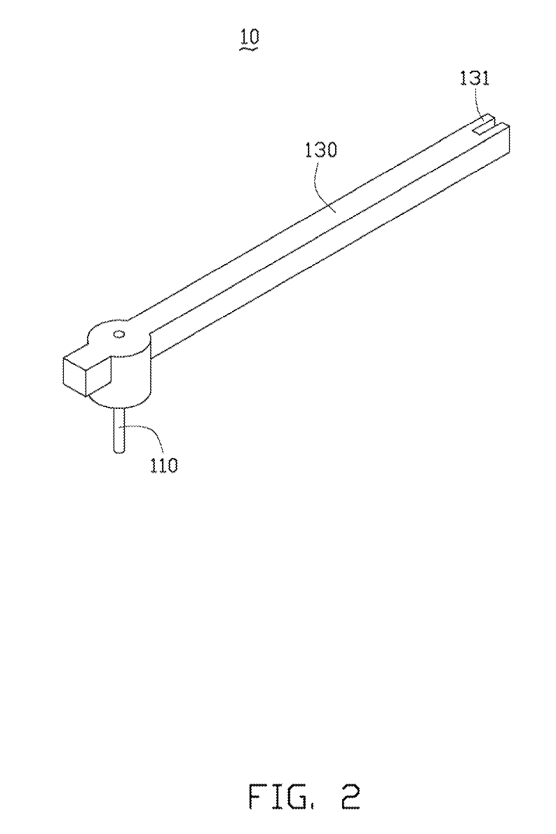

Referring also to FIG. 2, the rotating device 10 may include a spindle 110, a rotating arm 130, and a holding portion 131. The spindle 110 and the holding portion 131 are interconnected by the rotating arm 130. One of the ends of the rotating arm 130 defines a hole (not labeled), the spindle 110 is fixed in the hole, a rotating axis of the spindle 110 coincides with the center axis 11, and the rotating arm 130 rotates together with the spindle 110. The rotating arm 130 may be perpendicular to the spindle 110. The holding portion 131 is detachably mounted to the other end of the rotating arm 130 or integrally formed at the other end of the rotating arm 130. The first body 100 is held by the holding portion 131. In this illustrated embodiment, the first body 100 is a display panel. The first body 100 rotates together with the rotating arm 130 in a direction as indicated by the arrow X in FIG. 1.

The stationary device 30 is positioned on the path 13 traced by the first body 100. The stationary device 30 includes a main body 320 and a telescopic pole 310 mounted on the main body 320. The second body 300 is fixed to the telescopic pole 310. The telescopic pole 310 is extendable and can be stretched or shrunk in length. When the telescopic pole 310 is extended, the second body 300 is put on the path 13 traced by the first body 100 at a certain point C. When the telescopic pole 310 is retracted, the second body 300 is removed from the path 13 traced by the first body 100 and not subject to any impact or collision.

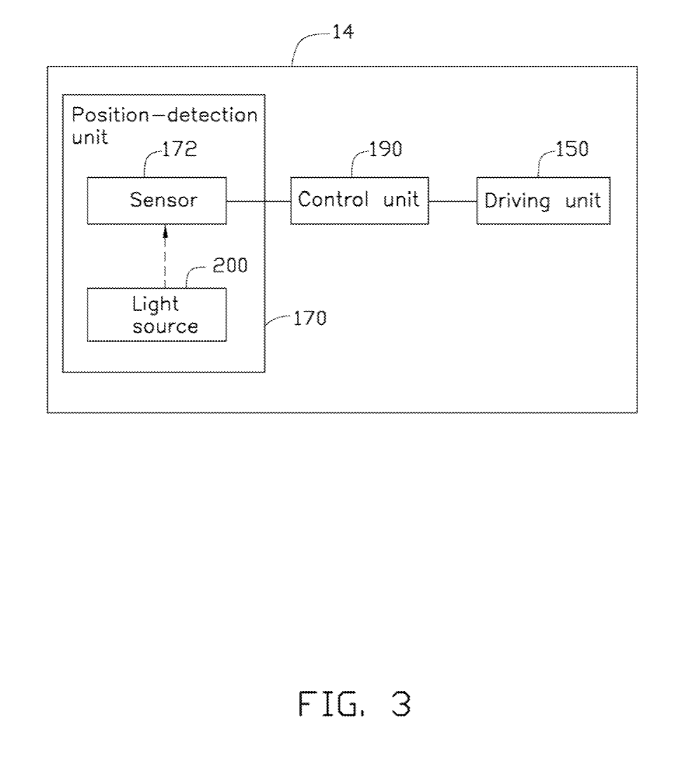

Referring also to FIG. 3, the test system 1 further includes a driving unit 150, a position-detection unit 170, and a control unit 190. The driving unit 150 is configured to drive the spindle 130 to rotate. The position-detection unit 170 is configured to detect when the first body 100 arrives at a point S of the path 13 traced by the first body 100 and generate a signal when the first body 100 arrives at point S of the path 13 traced by the first body 100 under the condition that the telescopic pole 310 is in the extended state.

The point S is located at a predetermined distance before the first body 100 arrives at the point C when the first body 100 is moving along the path 13 traced by the first body 100 in the X direction. The control unit 190 receives and processes the signal, and then outputs a control signal to turn off the driving unit 150. In this illustrated embodiment, the circumferential distance between the point S and the point C is 5 centimeters.

In this illustrated embodiment, the position-detection unit 170 includes a sensor 172 and a light source 200. The light source 200 is fixed outside the path 13 traced by the first body 100, with the light source 200, the point S of the path 13 traced by the first body 100, and a center of the path 13 traced by the first body 100 being in alignment. The light source 200 emits light beams, and the light beams pass through the point S of the path 13 traced by the first body 100 and are received by the sensor 172. When the first body 100 arrives at the point S, the light beams emitted from the light source 200 are blocked from the sensor 172. The sensor 172 generates a signal based on the change of the received light beams. In this illustrated embodiment, the driving unit 150 is a motor, and the light source is an infrared light source.

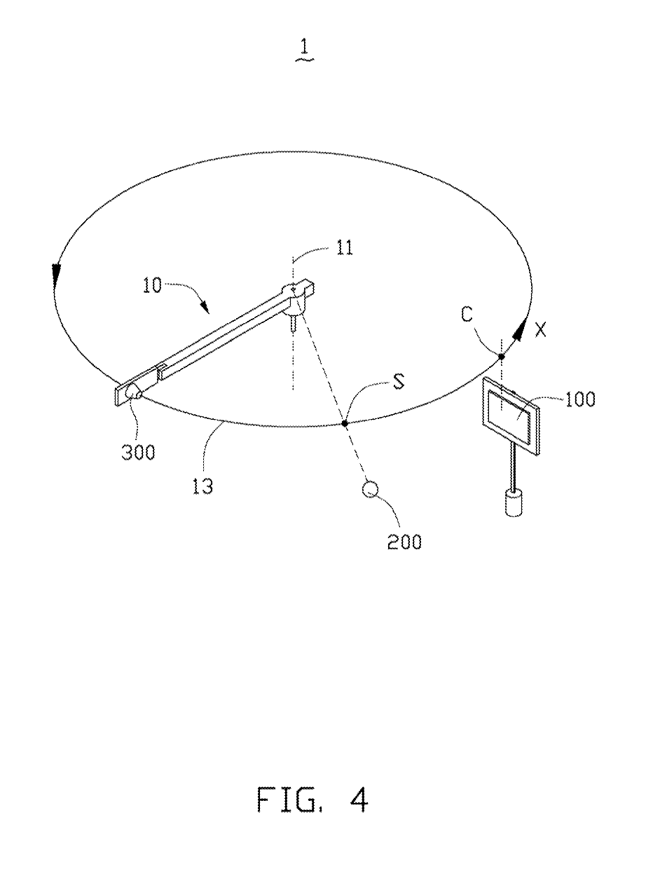

During testing, a tester can first fix the first body 100 to the rotating device 10, and fix the second body 300 to the stationary device 30 (see FIG. 1), and test the shock-resistance of the first body 100 when the first body 100 impacts the second body 300. After that, the tester can fix the first body 100 to the stationary device 30, fix the second body 300 to the rotating device 10 (see FIG. 4), and further test the shock-resistance of the first body 100 when the first body 100 is impacted by the second body 300. Then, the tester has two test situations from which the total shock-resistance of the first body 100 can be established. The precision of the testing of the shock-resistance of the first body 100 is thus improved.

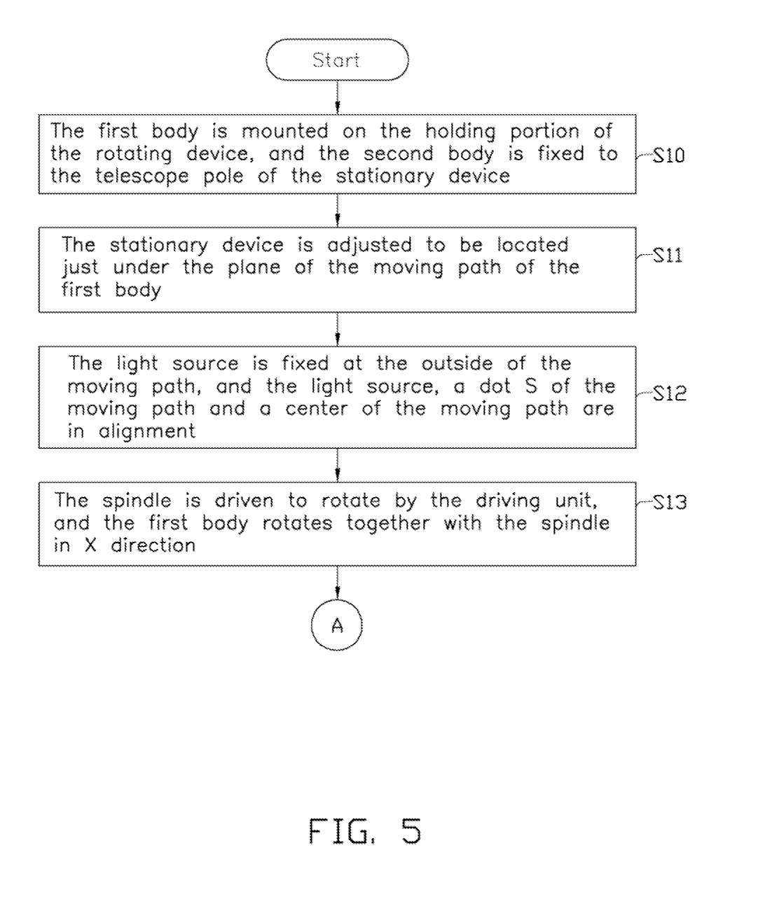

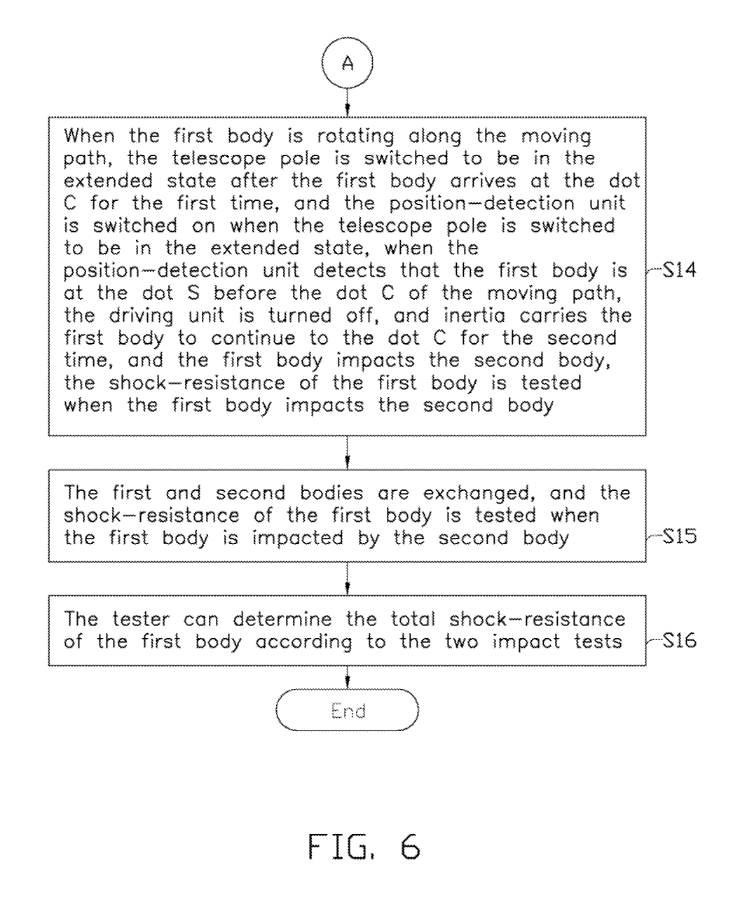

Referring to FIGS. 5-6, FIGS. 5-6 show a flowchart summarizing a method for testing the shock-resistance of the first body 100 according to an exemplary embodiment of the present disclosure. The testing steps are described below.

In step S10, the first body 100 is mounted on the holding portion 131 of the rotating device 10, and the second body 300 is fixed to the telescopic pole 310 of the stationary device 30.

In step S11, the stationary device 30 is adjusted to be located just under the plane of the path 13 traced by the first body 100. When the telescopic pole 310 is extended, the second body 300 intersects the path 13 traced by the first body 100 at point C, and when the telescopic pole 310 is retracted, the second body 300 drops below the plane of the path 13 traced by the first body 100.

In step S12, the light source 200 is fixed at the outside of the path 13 traced by the first body 100, so that the light source 200, the point S of the path 13 traced by the first body 100, and the center of the path 13 traced by the first body 100 are in alignment, therefore, the light beams emitted from the light source 200 pass through the point of point S of the path 13 traced by the first body 100 and be received by the sensor 172.

In step S13, the spindle 110 is driven to rotate by the driving unit 170, and the first body 100 rotates together with the spindle 110 in a direction as indicated by the arrow X in FIG. 1.

In step S14, when the first body 100 is rotating along the path 13, and in a period from when the first body arrives at the point C for the first time to when the first body arrives at the point C for the second time, the telescopic pole 310 is switched to be in the extended state after the first body 100 arrives at the point C for the first time, and the second body 300 is thereby on the path 13 at the point C. The position-detection unit 170 is switched on when the telescopic pole 310 is switched to be in the extended state. When the position-detection unit 170 detects that the first body 100 is at the point S of the path 13, the position-detection unit 170 outputs the signal to the control unit 190, and the control unit 190 turns off the driving unit 150. Inertia carries the first body 100 to continue to the point C for the second time, and the first body 100 impacts the second body 300. The shock-resistance of the first body 100 is tested when the first body 100 impacts the second body 300.

In step S15, the first and second bodies 100, 300 are exchanged (see FIG. 4), and the shock-resistance of the first body 100 when the first body is impacted by the second body 300 is tested.

In step S16, the tester can determine the total shock-resistance of the first body 100 according to the two impact tests, and the precision of the testing and therefore of the result of the testing of the first body 100 is thus improved.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A test system, comprising:
an impact body;
a rotating device configured to rotate around a center axis and hold one of a test object and the impact body, and take the one of the test object and the impact body to rotate; and
a stationary device configured to support the other one of the test object and the impact body and switch locations of the other one of the test object and the impact body between a location on a path traced by the one of the test object and the impact body held by the rotating device and another location away from the path;
wherein each of the test object and the impact body is capable of being held by the rotating device; and each of the test object and the impact body is capable of being fixed to the stationary device.

2. The test system of claim 1, wherein the rotating device comprises a spindle, a rotating arm and a holding portion, the spindle and the holding portion are interconnected by the rotating arm.

3. The test system of claim 2, wherein the rotating arm comprises two opposite ends, one of the two opposite ends of the rotating arm defines a hole, the spindle is fixed in the hole, a rotating axis of the spindle coincides with the center axis, and the rotating arm rotates together with the spindle, the holding portion is detachably mounted to the other end of the rotating arm or integrally formed at the other end of the rotating arm, and the one of the test object and the impact body is held by the holding portion.

4. The test system of claim 3, wherein the rotating arm is perpendicular to the spindle.

5. The test system of claim 3, wherein the stationary device comprises a main body and a telescopic pole mounted on the main body, the other one of the test object and the impact body is fixed to the telescopic pole, the telescopic pole is extendable and switchable to be in a extended state or a retracted state, when the telescopic pole is in the extended state, the other one of the test object and the impact body is on the path traced by the one of the test object and the impact body held by the rotating device at a point C, when the telescopic pole is in the retracted state, the other one of the first and second bodies is away from the path.

6. The test system of claim 5, further comprising a driving unit, a position-detection unit and a control unit, wherein the driving unit is configured to drive the spindle to rotate, the position-detection unit is configured to detect when the one of the test object and the impact body held in the rotating device arrives at a point S of the path and generate a signal to the control unit when the one of the test object and the impact body held in the rotating device arrives at the point S of the path under a condition that the telescopic pole is in the extended state, the point S is located at a predetermined distance before the one of the test object and the impact body held in the rotating device arrives at the point C of the path when the one of the test object and the impact body is moving along the path.

7. The test system of claim 6, wherein the control unit receives and processes the signal, and outputs a control signal to turn off the driving unit.

8. The test system of claim 7, wherein the position-detection unit comprises a sensor and a light source, the light source is fixed outside the path traced by the one of the test object and the impact body held by the rotating device, the light source, the point S of the path, and a center of the path are in alignment, the light source emits light beams, and the light beams pass through the point S of the path and are received by the sensor, when the one of the test object and the impact body arrives at the point S of the path, the light beams emitted from the light source are blocked from the sensor and can not impinge the sensor, the sensor generates the signal based on the change of the received light beams.

9. The test system of claim 8, wherein the light source is infrared light source.

10. A test method for testing a shock-resistance of a test object, comprising:
providing an impact test system, the impact test system configured to simulate an impact between the test object and an impact body, the impact test system comprising a rotating device configured to rotate around a center axis and hold one of the test object and the impact body and a stationary device configured to support the other one of the test object and the impact body, the rotating device taking the one of the test object and the impact body to rotate, the stationary device switching locations of the other one of the test object and the impact body between a location on a path traced by the one of the test object and the impact body held by the rotating device and another location away from the path;
fixing one of the test object and the impact body to the rotating device, and the other one of the test object and the impact body to the stationary device;
driving the rotating device to rotate, with the one of the test object and the impact body rotating together with the rotating device;
adjusting the stationary device to enable the other one of the first and second bodies to be located on the path traced by the one of the test object and the impact body held by the rotating device;
testing a shock-resistance of the test object when the impact between the test object and the impact body is generated; and
exchanging the test object and the impact body to generate another impact, and obtaining another shock-resistance of the test object, the other one of the test object and the impact body is fixed to the rotating device and the one of the test object and the impact body is fixed to the stationary device; and
testing the total shock-resistance of the test object according to the two impacts between the test object and the impact body.

11. The test method of claim 10, wherein the rotating device comprises a spindle, a rotating arm and a holding portion, the spindle and the holding portion are interconnected by the rotating arm, and one of the test object and the impact body is held in the holding portion.

12. The test method of claim 11, wherein the rotating arm comprises two opposite ends, one of the two opposite ends of the rotating arm defines a hole, the spindle is fixed in the hole, a rotating axis of the spindle coincides with the center axis, and the rotating arm rotates together with the spindle, the holding portion is detachably mounted to the other end of the rotating arm or integrally formed at the other end of the rotating arm.

13. The test method of claim 11, wherein the rotating arm is perpendicular to the spindle.

14. The test method of claim 11, wherein the stationary device comprises a main body and a telescopic pole mounted on the main body, the telescopic pole is extendable and switchable to be in a extended state or a retracted state, when the telescopic pole is in the extended state, one of the test object and the impact body fixed to the telescopic pole is on the path traced by one of the test object and the impact body held by the rotating device at a point C, when the telescopic pole is in the retracted state, one of the test object and the impact body fixed to the telescopic pole is away from the path traced by one of the test object and the impact body held by the rotating device.

15. The test method of claim 14, wherein the impact test system further comprises a driving unit, a position-detection unit and a control unit, the spindle is driven to rotate by the driving unit, the position-detection unit is configured to detect when one of the test object and the impact body held by the rotating device arrives at a point S of the path and generates a signal to the control unit when one of the test object and the impact body held by the rotating device arrives at the point S of the path under a condition that the telescopic pole is in the extended state, the point S of the path is located at a predetermined distance before one of the test object and the impact body held by the rotating device arrives at the point C of the path when one of the test object and the impact body held by the rotating device is moving along the path.

16. The test method of claim 15, wherein the control unit receives and processes the signal, and outputs corresponding control signal to switch off the driving unit.

17. The test method of claim 16, wherein the position-detection unit comprises a sensor and a light source, the light source is fixed outside the path traced by one of the test object and the impact body held by the rotating device, the light source, the point S of the path, and a center of the path are in alignment, the light source is configured to emit light beams, and the light beams passes through the point S of the path and are received by the sensor, when one of the test object and the impact body held by the rotating device arrives at the point S of the path, the light beams emitted from the light source are blocked from the sensor and can not impinge the sensor, the sensor generates the signal based on the change of the received light beams.

18. The test method of claim 17, wherein the light source is infrared light source.
